(19) United States
(12) Patent Application Publication
(10) Pub. No.: US 2013/0231948 A1
(43) Pub. Date: Sep. 5, 2013

(54) METHOD AND APPARATUS FOR PROVIDING HEALTH CARE SERVICE USING UNIVERSAL PLUG AND PLAY

(71) Applicant: SAMSUNG ELECTRONICS CO., LTD., Gyeonggi-do (KR)

(72) Inventors: Jun-Hyung KIM, Gyeonggi-do (KR); Jong-Hyo LEE, Gyeonggi-do (KR)

(73) Assignee: Samsung Electronics Co., Ltd., Gyeonggi-do (KR)

(21) Appl. No.: 13/785,930

(22) Filed: Mar. 5, 2013

(30) Foreign Application Priority Data
Mar. 5, 2012 (KR) 10-2012-0022461

(51) Int. Cl. G06F 19/00

(52) U.S. Cl. CPC G06F 19/3418
USPC 705/2

(57) ABSTRACT

A method and apparatus for providing a health care service are provided. The method includes receiving situation occurrence information indicating an occurrence of a situation, which has occurred to a user, from a user device included in a Universal Plug and Play (UPnP) network; identifying health care information of the user based on the situation occurrence information; providing the health care information of the user to a health care server; and sending, to the health care server, a request to be provided with the health care service to the user device.

### PRIORITY

This application claims the priority under 35 U.S.C. §119(a) to Korean Application Serial No. 10-2012-0022461, which was filed in the Korean Intellectual Property Office on Mar. 5, 2012, the entire content of which is incorporated herein by reference.

### BACKGROUND OF THE INVENTION

1. Field of the Invention The present invention relates generally to a health care technology, and more particularly, to a method and an apparatus for providing a health care service using a Universal Plug and Play (UPnP) network.

2. Description of the Related Art

Current populations are rapidly increasing and aging globally as well as domestically. Accordingly, social costs for health care of the aged are also rapidly increasing. Personal and national expenses used for management of adult obesity patients or management of chronic illness are also increasing. As personal attention to health is increasing, personal costs are also increasing. Due to national financial pressures related to medical and health maintenance costs, medical services have shifted from primarily treatment-based services towards prevention and diagnosis-based services.

In order to keep up with these changes in medical services, various technologies have been developed according to a fusion of Information Technology (IT) and the medical industry, as many companies join together in their efforts to develop new medical services.

In particular, currently-provided health care services for managing elderly or chronic patients are configured primarily to provide messages having preset content or provide calls to a preset number by using a particular button arranged in a personal mobile communication terminal. However, in order to use such a health care service, the user must always carry the mobile communication terminal, even indoors, which may feel inconvenient to some users. A small-sized terminal dedicated for health care services has been proposed to reduce such an inconvenience, but the user would be required to pay a separate service fee for emergency calls in order to use such a dedicated terminal.

### SUMMARY OF THE INVENTION

The present invention has been made to solve the above-mentioned problems, and an aspect of the present invention is to provide a method and an apparatus for providing a health care service capable of more efficiently providing the health care service by re-using Universal Plug and Play (UPnP) and Digital Living Network Alliance (DLNA) infrastructure.

In accordance with an aspect of the present invention, a method of providing a health care service by a healthcare gateway comprised in a healthcare system is provided. The method includes receiving situation occurrence information indicating an occurrence of a situation, which has occurred to a user, from a user device included in a Universal Plug and Play (UPnP) network; identifying health care information of the user based on the situation occurrence information; providing the health care information of the user to a health care server; and sending, to the health care server, a request to be provided with the health care service to the user device.

In accordance with another aspect of the present invention, a method of receiving a health care service by a user device comprised in a Universal Plug and Play (UPnP) network is provided. The method includes receiving, from a user, an occurrence of a situation, which has occurred to the user; generating situation occurrence information based on the occurrence of the situation; and sending, to a gateway device comprised in the UPnP network, a request for the health care service by transmitting the situation occurrence information.

In accordance with another aspect of the present invention, an apparatus to be provided with a health care service is provided. The apparatus includes a health care processor for receiving situation occurrence information indicating an occurrence of a situation, which has occurred to a user, from a user device included in a Universal Plug and Play (UPnP) network, identifying situation information comprised in the situation occurrence information and health care information on the user, and controlling to a data transmission data processor to send a request to be provided with the health care service to the user device; and the data transmission processor for providing the health care information on the user to a health care server in order to provide the health care service.

### BRIEF DESCRIPTION OF THE DRAWINGS

The above and other objects, features and advantages of certain embodiments of the present invention will be more apparent from the following detailed description taken in conjunction with the accompanying drawings, in which:

FIG. 1 is a diagram schematically illustrating a configuration of a health care information providing system according to an embodiment of the present invention;

FIG. 2 is a signal flowchart illustrating a health care service providing method according to a first embodiment of the present invention;

FIG. 3 is a diagram illustrating an example of situation occurrence information according to the first embodiment of the present invention;

FIG. 4 is a block diagram illustrating a configuration of a health care gateway according to the first embodiment of the present invention;

FIG. 5 is a signal flowchart illustrating a health care service providing method according to a second embodiment of the present invention;

FIG. 6 is a diagram illustrating an example of a GetCondition message according to the second embodiment of the present invention;

FIG. 7 is a block diagram illustrating a configuration of a health care device according to the second embodiment of the present invention; and

FIG. 8 is a block diagram illustrating a configuration of a health care gateway according to the second embodiment of the present invention.

### DETAILED DESCRIPTION OF EMBODIMENTS OF THE PRESENT INVENTION

Hereinafter, various embodiments of the present invention are described with reference to the accompanying drawings. In the following description, the same or similar elements may be designated by the same reference numerals in different drawings. Further, various specific definitions found in the following description are merely provided to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

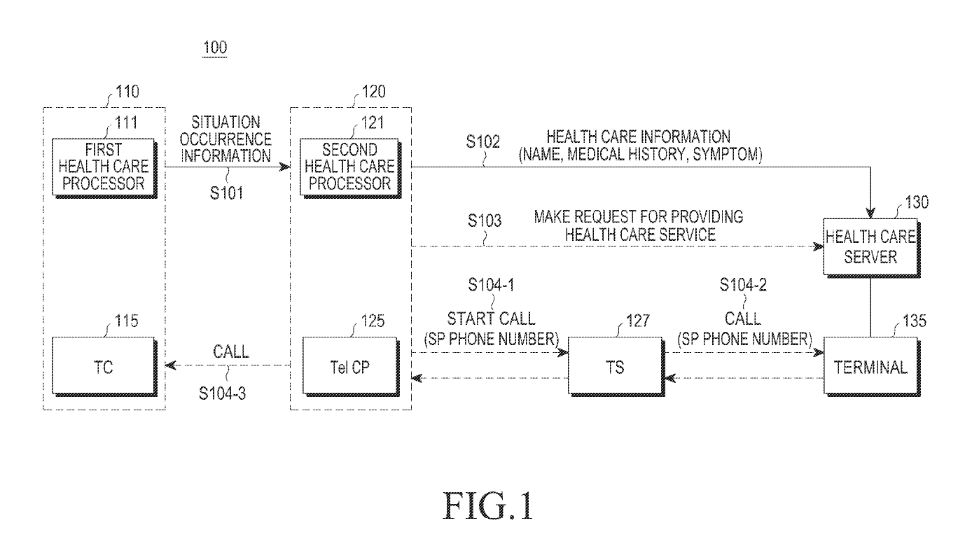

FIG. 1 is a diagram schematically illustrating a configuration of a health care information providing system according to an embodiment of the present invention.

Referring to FIG. 1, a health care information providing system 100 according to an embodiment of the present invention includes a health care device 110 for generating a user-request to be provided with a health care service, a health care gateway 120 for transmitting health care information regarding a user that initiated the request to be provided with the health care service and performing a control operation corresponding to the request to be provided with the health care service, and a health care server 130 for providing the health care service.

The health care device 110 and the health care gateway 120 are connected to each other through a general Universal Plug and Play (UPnP) network, and the health care gateway 120 and the health care server 130 are connected to each other by a communication network such as an Internet network.

An operation of the health care information providing system 100 may be initiated by situation occurrence information generated by the health care device 100. More specifically, when the health care device 110 generates the situation occurrence information and transmits the situation occurrence information to the health care gateway 120 in step S101, the health care gateway 120 identifies health care information corresponding to the situation occurrence information among health care information stored internally (or externally) and provides the identified health care information to the health care server 130 in step S102. Further, the health care gateway 120 generates a request to be provided with a health care service by the health care server 130 (for example, a server operated by a hospital or an emergency medical center providing the health care service) in step S103.

For example, the provided health care service may be a service for providing emergency aid to the user using the health care device 110 through the hospital or the emergency medical center providing the health care service. Further, as an alternative to the health care gateway 120 generating the request for the health care server 130 to provide the health care service, the health care gateway 120 may connect a call with the hospital or the emergency medical center providing the health care service. To this end, the health care information providing system 100 may be configured to support a UPnP telephony service. More specifically, the health care device 110 includes a Telephony Client (TC) 115 for the UPnP telephony service, the health care gateway 120 includes a UPnP telephony Control Point (CP) 125, and the health care information providing system includes a telephony server 127 for processing the call connection between the UPnP telephony CP 125 and the hospital or the emergency medical center providing the health care service.

Accordingly, in order to perform the call connection with the hospital providing the health care service or the emergency medical center, the health care gateway 120 instructs the telephony server 127 to initiate the call connection by using the UPnP telephony CP 125 in step S104-1, the telephony server 127 attempts the call connection with a service provider for providing the health care service (i.e., a terminal 135 arranged in the hospital or the emergency medical center) in step S104-2, and calls among the telephony client 115, the UPnP telephony CP 125, and the telephony server 127 are initiated in step S104-3.

Meanwhile, the health care device 110 and the health care gateway 120 are basically configured to serve as a UPnP CP or a UPnP server included in the UPnP network. Accordingly, the health care device 110 includes a first health care processor 111 for serving as the UPnP CP or the UPnP server, and the health care gateway 120 includes a second health care processor 121 for serving as the UPnP CP or the UPnP server. More specifically, the second health care processor 121 is configured to operate as the UPnP server when the first health care processor 111 is configured to operate as the UPnP CP, and the second health care processor 121 is configured to operate as the UPnP CP when the first health care processor 111 is configured to operate as the UPnP server.

The health care device 110 may be carried by the user or fixed to the user while being in contact with a user's body, so that the operation of the health care device 110 is controlled by the user using the health care service.

The health care device 110 may include at least one input button, and the first health care processor 111 can initiate an operation for making the request to be provided with the health care service as the at least one input button is pressed by the user, such as during an emergency.

Although according to the above-described embodiment of the present invention, the first health care processor 111 initiates the operation for making the request to be provided with the health care service as the at least one input button is pressed by the user, the present invention is not limited thereto. For example, the health care device 110 may further include a sensor (not shown) for detecting a biological signal of the user (e.g., blood pressure, pulse, temperature, blood glucose, etc), and the first health care processor 111 can actively initiate the request to be provided with the health care service by comparing a value input from the sensor with a predetermined reference (a medically set danger level reference).

Meanwhile, the generation of the request to be provided with the health care service may include transmitting information corresponding to the at least one input button to the health care gateway 120. To this end, the first health care processor 111 can store an address of the health care gateway 120 to which the information corresponding to the at least one input button is transmitted.

The information corresponding to the at least one input button may be situation occurrence information, and the situation occurrence information may contain an inherent identifier allocated to the health care device 110 and a code indicating a situation occurrence to allow an operation designated by the user to be performed. Further, the code indicating the situation occurrence may be information indicating that an emergency is generated as well as information indicating a predetermined emergency matched with the at least one input button.

When the first health care processor 111 operates as the UPnP CP, the first health care processor 111 can directly transmit the situation occurrence information to the second health care processor 121 operating as the UPnP server. As an alternative, when the first health care processor 111 operates as the UPnP server, the first health care processor 111 may be configured to first transmit a message indicating that an event is generated to the second health care processor 121 operating as the UPnP CP, and then transmit the situation occurrence information to the second health care processor 121 requesting the situation occurrence information in order to generate the request for first providing the health care service.

Meanwhile, the health care gateway 120 pre-stores health care information mapped with the situation occurrence information. The health care information may contain information that is referred to when the health care service is provided, and may include, for example, a name, medical history, a symptom, etc. of the user using the health care device 110. Further, the health care gateway 120 can store a phone number of the terminal 135 of the health care service provider mapped into the code indicating the situation occurrence.

Accordingly, when the health care gateway 120 receives the situation occurrence information from the health care device 110, the health care gateway 120 identifies the health care information corresponding to the situation occurrence information and provides the identified health care information to the health care server 130. Further, the health care gateway 120 requests aid for the user using the health care device 110 by a server operated by the hospital or the emergency medical center providing the health care service, or attempts a call connection with the terminal 135 arranged in the hospital or the emergency medical center providing the health care service.

Hereinafter, detailed configurations of a method and an apparatus for providing the health care service using the aforementioned health care providing system 100 according to an embodiment of the present invention are described.

A method and an apparatus for providing the health care service according to an embodiments of the present invention is differently configured according to respective operations performed by the first health care processor 111 included in the health care device 110 and the second health care processor 121 included in the health care gateway 120. Such operations correspond to operations of a UPnP CP and a UPnP server.

Accordingly, the first health care processor 111 operates as the UPnP CP and the second health care processor 121 operates as the UPnP server in a method and an apparatus for providing the health care service according to a first embodiment of the present invention. Meanwhile the first health care processor 111 operates as the UPnP server and the second health care processor 121 operates as the UPnP CP in a method and an apparatus for providing the health care service according to a second embodiment of the present invention

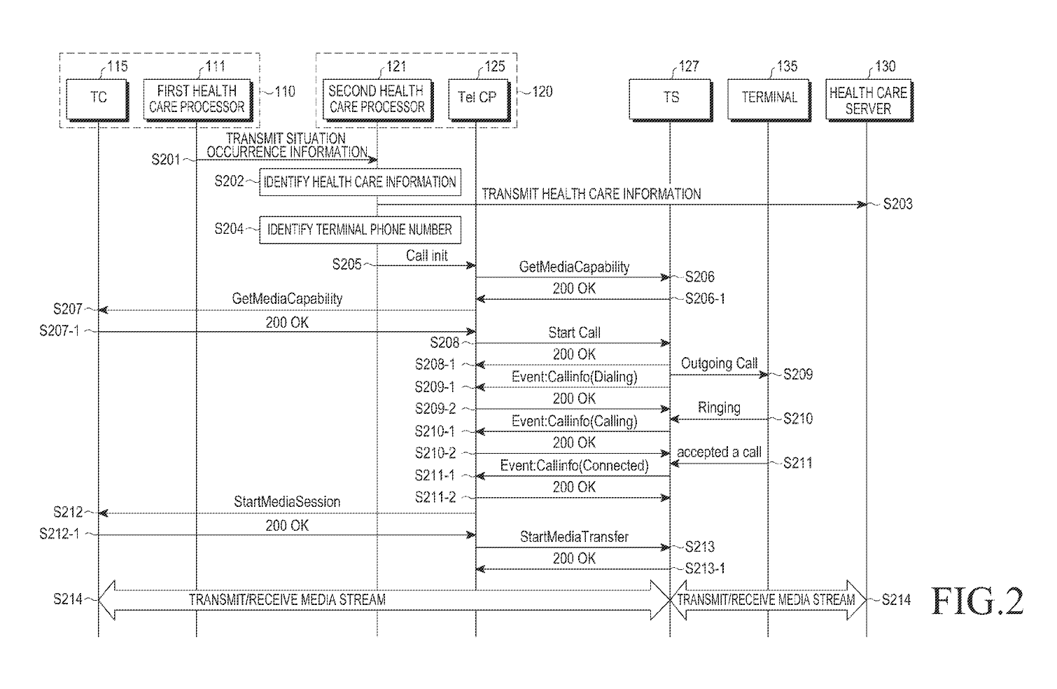

FIG. 2 is a signal flowchart illustrating a health care service providing method according to the first embodiment of the present invention.

Referring to FIG. 2, in the health care service providing method according to the first embodiment of the present invention, as at least one input button arranged in the health care device 110 is pressed, the first health care processor 111 generates situation occurrence information and transmits the situation occurrence information to the health care gateway 120, in step S201.

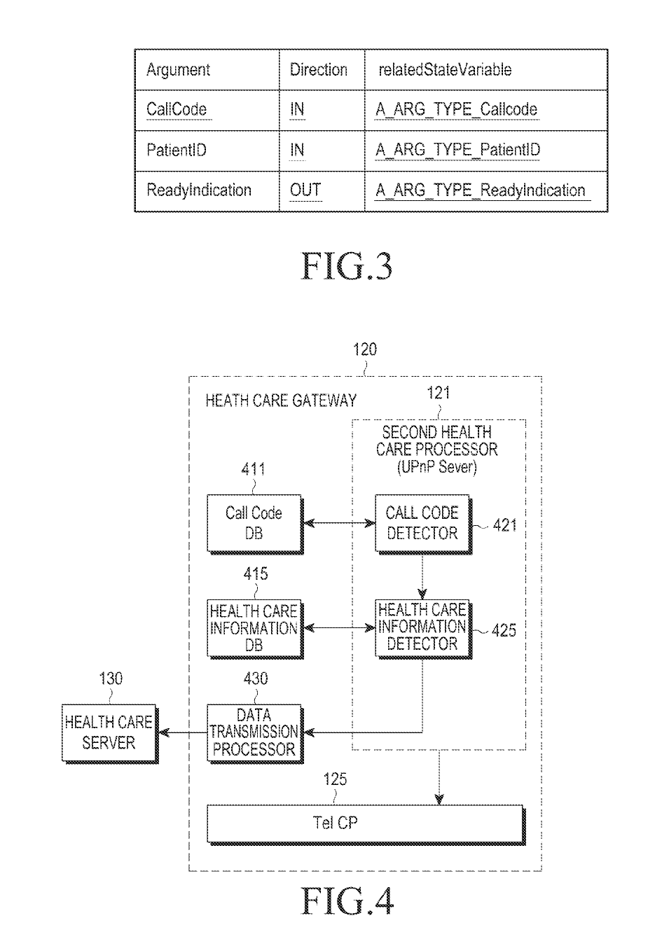

The situation occurrence information may be configured as illustrated in FIG. 3. FIG. 3 illustrates an example of situation occurrence information used in the health care service providing method according to the first embodiment of the present invention.

Referring to FIG. 3, the situation occurrence information contains a code (Callcode) indicating a situation occurrence and an identifier (PatentID) of the health care device 110. For example, the code (Callcode) indicating the situation occurrence defines information on a state of a patient, and may be a code preset in accordance with the at least one input button arranged in the health care device 110, for example, a code indicating an emergency, a code making a request for a call with a doctor or the like.

Further, the health care gateway 120 can transmit a response message to the health care device 110 in response to successful reception of the situation occurrence information. The response message may contain a waiting indicator (ReadyIndication). The waiting indicator (ReadyIndication) is used as information for preventing the situation occurrence information from being repeatedly transmitted when the user continuously presses an input button arranged in the health care device 110. As a response to the continuous input button press, the health care gateway 120 sets a value of the waiting indicator (Ready Indication) as True and transmits the set value to the health care device 110. Accordingly, the health care device 110 does not repeatedly transmit the situation occurrence information when the input button is continuously input by the user.

Next, the health care gateway 120 identifies what the code (Callcode) indicating the situation occurrence included in the situation occurrence information indicates from a pre-stored database, and identifies health care information corresponding to an inherent identifier allocated to the health care device 110 in step S202.

Next, the health care gateway 120 transmits the health care information to the health care server 130 in step S203.

Further, the health care gateway 120 performs generates the request to be provided with the health care service. For example, the operation of requesting to be provided with the health care service may include providing a call connection with the health care device 110 to the terminal 135 of the service provider mapped into and stored in the code (Callcode) indicating the situation occurrence by using a telephony service.

The health care gateway 120 identifies a phone number of the terminal 135 mapped into and stored in the code (Callcode) indicating the situation occurrence in order to connect calls with the terminal 135 and the health care device 110 in step S204, and transmits a call initialization command (Call Initiation) to allow the telephony CP 125 included in the health care gateway 120 to perform a call service by using the phone number, in step S205. Then, the telephony CP 125 transmits a GetMediaCapability( ) message to the telephony server 127 in order to identify information on the telephony server 127 for the call connection in step S206, and acquires the information on the telephony server 127 in response to the transmission of the GetMediaCapability( ) message in step S206-1. The telephony CP 125 transmits the GetMediaCapability( ) message to the telephony client 115 in order to identify information on the telephony client 115 for the call connection in step S207, and acquires the information on the telephony client 115 in response to the transmission of the GetMediaCapability( ) message in step S207-1.

The telephony CP 125 requests the phone call by transmitting a StartCall( ) message containing the phone number of the terminal 135 to the telephony server 127 in steps S208 and S208-1.

The telephony server 127 requests the terminal 135 to perform the call according to the StartCall( ) message in step S209, and transmits an Event message for informing that an outgoing call is successfully performed to the telephony CP 125 in step S209-1.

When a call is normally transmitted to the terminal 135, the telephony server 127 receives a Ringing message from the terminal 135 in step S210, and transmits again the Event message for informing of the reception of the Ringing message to the telephony CP 125 in step S210-1.

Further, when the terminal 135 accepts the call and thus the telephony server 127 receives a call message from the terminal 135 in step S211, the telephony server 127 transmits the Event message for informing that the call is connected to the telephony CP 125 in step S211-1.

The telephony CP 125 transmits, to the telephony client 115, a message instructing the telephony client 115 to prepare the call connection by transmitting a StartMediaSession( ) message in steps S212 and S212-1. Further, when both the telephony server 127 and the telephony client 115 are ready for the call connection, the telephony CP 125 requests transmission of a media stream for the call with the terminal 135 by transmitting a StartMediaTransfer( ) message to the telephony server 127 in steps S213 and S213-1. In addition, the telephony server 127 transmits/receives the media stream for the call between the terminal 135 and the telephony client 115.

FIG. 4 is a block diagram illustrating a configuration of the health care gateway 120 according to the first embodiment of the present invention.

Referring to FIG. 4, the health care gateway 120 includes a call code database 411 for storing information describing what is indicated by each situation occurrence code and information into which an IDentifier (ID) of the health care device 110 and a user of the health care device 110 are mapped, and a health care information database 415 for storing health care information regarding the user corresponding to the device ID. The health care information may contain information referred to when the health care service is provided, and may include, for example, a name, medical history, a symptom, etc. of the user using the health care device 110.

Further, the health care gateway 120 basically operates as a UPnP server, and includes a second health care processor 121 for processing an operation for providing the health care service requested by the health care device 110. The second health care processor 121 includes a call code detector 421. When the situation occurrence information is received, the call code detector 421 identifies information indicated by the situation occurrence code included in the situation occurrence information from the call code database 411.

In addition, the second health care processor 121 includes a health care information detector 425. The health care information detector 425 identifies an identifier of the user corresponding to the identifier of the health care device 110 from the call code database 411, and identifies health care information corresponding to the user ID from the health care information database 415.

The health care information identified by the health care information detector 425 is provided to a data transmission processor 430, and the data transmission processor 430 transmits the health care information after converting a format of the health care information to a predetermined format so that the health care information is identifiable by the health care server 130. For example, the health care server 130 may be configured to display the health care information through web browsers, and accordingly, the data transmission processor 430 may transmit the health care information after converting the health care information so that the health care information can be provided through the web browser.

Further, the second health care processor 121 can perform a telephony service in order to provide the health care service, and may include the telephony CP 125 for processing the telephony service. The telephony CP 125 is a component for processing a general telephony service, and controls a call connection among the telephony client 115 included in the health care device 110 of the health care providing system 100, the telephony server 127, and the terminal 135 of the health care service provider according to the present invention and controls transmission/reception of the media stream for the call. More specifically, the telephony CP 125 controls the operations performed in steps S206 to S214 included in the aforementioned health care service providing method according to the first embodiment of the present invention.

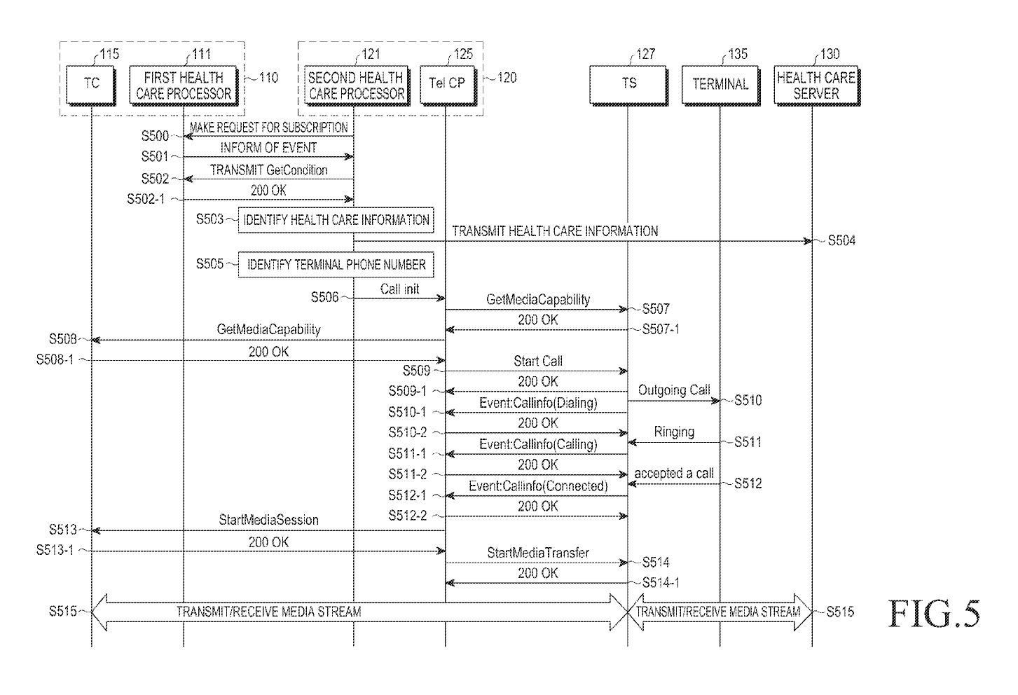

FIG. 5 is a signal flowchart illustrating a health care service providing method according to a second embodiment of the present invention.

Referring to FIG. 5, the second health care processor 121 operating as the UPnP client included in the health care gateway 120 requests the first health care processor 111 operating as the UPnP server included in the health care device 110 to subscribe to an event through a pre-processing operation in step S500.

Thereafter, as at least one input button arranged in the health care device 110 is pressed, the first health care processor 111 transmits, to the second health care processor 121 of the health care gateway 120, a message indicating that the event is generated, in step S501.

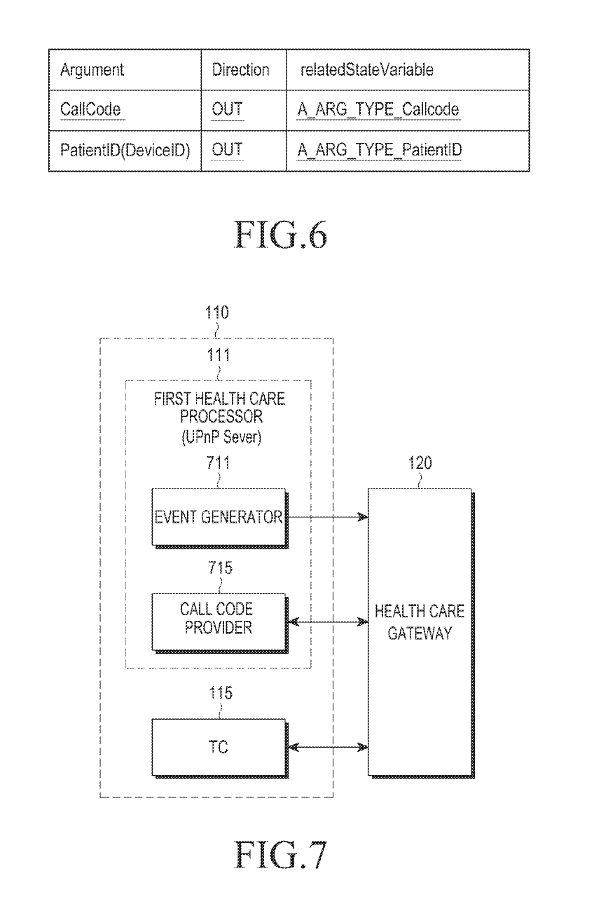

Then, the second health care processor 121 transmits a GetCondition( ) message for making a request for situation occurrence information by the first health care processor 111 in order to identify the situation occurrence information in step S502, and transmits a response message (200 OK) containing the situation occurrence information, in step S502-1. At this time, the GetCondition( )message is used to acquire the situation occurrence information, and may contain a code (Callcode) indicating a situation occurrence and an identifier (Patient ID) of the health care device 110 as illustrated in FIG. 6.

FIG. 6 is a diagram illustrating an example of a GetCondition message used in the health care service providing method according to the second embodiment of the present invention.

Referring to FIG. 6, for example, the code (Callcode) indicating the situation occurrence defines information on a state of a patient, and may be a code preset in accordance with at least one input button arranged in the health care device 110, for example, a code indicating an emergency, a code for making a request for a call with a doctor, etc.

Meanwhile, the health care gateway 120 can transmit a response message to the health care device 110 in response to successful reception of the situation occurrence information. The response message may contain a waiting indicator (ReadyIndication), and the waiting indicator (ReadyIndication) is used to prevent the situation occurrence information from being repeatedly transmitted when the user continuously presses an input button arranged in the health care device 110. More specifically, as a response to the continuous input button press, the health care gateway 120 sets a value of the waiting indicator (Ready Indication) as True and transmits the set value to the health care device 110. Accordingly, the health care device 110 does not repeatedly transmit the situation occurrence information when the input button is continuously input by the user.

Hereinafter, since steps S503 to S515 are similar to steps S202 to S214 included in the health care service providing method according to the first embodiment of the present invention, a further description of steps S503 to S515 is omitted for clarity and conciseness.

FIG. 7 is a block diagram illustrating a configuration of a health care device according to the second embodiment of the present invention.

Referring to FIG. 7, the health care device 110 basically operates as a UPnP server, and includes the first health care processor 111 for processing an operation of the health care service.

The first health care processor 111 includes an event generator 711 and a call code provider 715.

The event generator 711 receives a request to subscribe to event generation from the health care gateway 120 in advance through a connection with the health care gateway 120, and stores the request. The first health care processor 111 generates an event message indicating that an event is generated when at least one input button arranged in the health care device 110 is pressed, and transmits the event message to the health care gateway 120 that requested the subscription.

The call code provider 715 receives a message (i.e., a GetCondition( ) message) requesting situation occurrence information from the health care gateway 120, identifies the situation occurrence information corresponding to the event, and provides the situation occurrence information to the health care gateway 120. The situation occurrence information contains a code (Callcode) indicating a situation occurrence and an identifier (Patient ID) of the health care device. For example, the code (Callcode) indicating the situation occurrence defines information on a state of a patient, and may be a code preset in accordance with the at least one input button arranged in the health care device 110, for example, a code indicating an emergency, a code making a request for a call with a doctor or the like.

Further, the health care device 110 operates under a control of the telephony CP 125, and includes the telephony client 115 for processing a telephony service with the telephony server 127 and the external terminal 135.

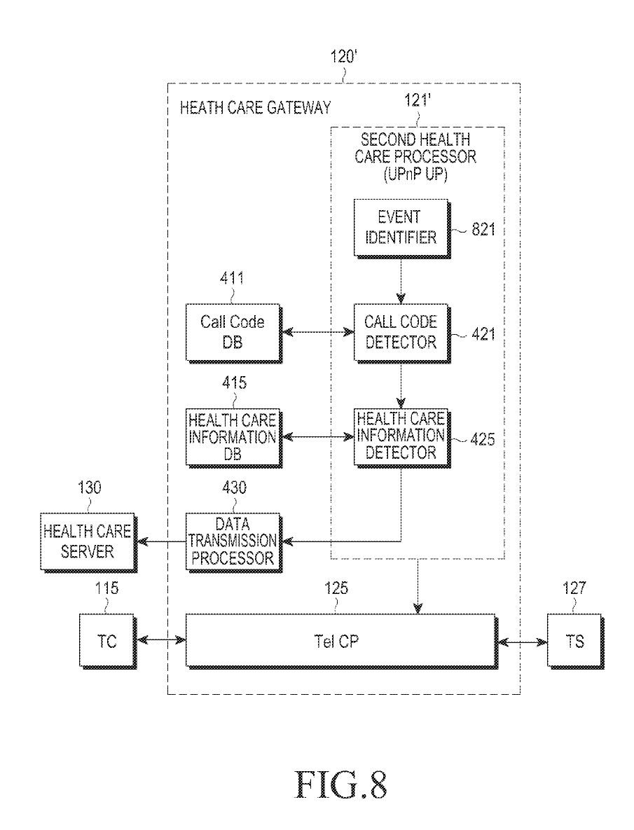

FIG. 8 is a block diagram illustrating a configuration of a health care gateway according to the second embodiment of the present invention.

Referring to FIG. 8, the health care gateway 120′ includes a call code database 411 for storing information describing what is indicated by each situation occurrence code and information into which an ID of the health care device 110 and a user of the health care device 110 are mapped, and a health care information database 415 for storing health care information on the user corresponding to the device ID. The health care information may contain information referred to when the health care service is provided, and the information may include, for example, a name, medical history, a symptom, etc. of the user using the health care device 110.

The health care gateway 120 basically operates as the UPnP server, and includes a second health care processor 121′ for processing an operation for providing the health care service requested by the health care device 110. The second health care processor 121′ includes an event identifier 821. The event identifier 821 requests the health care device 110 for subscription, and performs an operation of transmitting the GetCondition( ) message for making a request for the situation occurrence information when receiving the event from the health care device 110.

In addition, the second health care processor 121′ includes the call code detector 412, and the call code detector 421, upon receiving the situation occurrence information, identifies information corresponding to a situation occurrence code included in the situation occurrence information indicates from the call code database 411.

In addition, the second health care processor 121′ includes the health care information detector 425. The health care information detector 425 identifies an identifier of the user corresponding to the identifier of the health care device 110 from the call code database 411, and identifies health care information corresponding to the identifier of the user from the health care information database 415.

The health care information identified by the health care information detector 415 is provided to the data transmission processor 430, and the data transmission processor 430 transmits the health care information after converting a format of the health care information to a predetermined format so that the health care information is identifiable by the health care server 130. For example, the health care server 130 may be configured to display the health care information through web browsers, and accordingly, the data transmission processor 430 may transmit the health care information after converting the health care information so that the health care information can be provided through the web browser.

The health care gateway 120′ can also perform a telephony service in order to provide the health care service, and may include the telephony CP 125 for processing the telephony service. The telephony CP 125 is a component that processes a general telephony service, and controls a call connection among the telephony client 115 included in the health care device 110 of the health care providing system 100 according to an embodiment the present invention, the telephony server 127, and the terminal 135 of the health care service provider and controls transmission/reception of the media stream for the call. More specifically, the telephony CP 125 controls the operations performed in steps S507 to S515 included in the aforementioned health care service providing method according to the second embodiment of the present invention.

According to the health care service providing method and apparatus according to embodiments of the present invention, the user can receive the health care service by using a UPnP or DLNA infrastructure without incurring separate service costs, while conveniently carrying the health care service providing apparatus.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method of providing a health care service by a healthcare gateway comprised in a healthcare system, comprising:
receiving situation occurrence information indicating an occurrence of a situation, which has occurred to a user, from a user device included in a Universal Plug and Play (UPnP) network;
identifying health care information of the user based on the situation occurrence information;
providing the health care information of the user to a health care server; and
sending, to the health care server, a request to be provided with the health care service to the user device.

2. The method of claim 1, wherein sending the request to be provided with the health care service to the user device comprises informing the health care server of the situation.

3. The method of claim 1, wherein sending the request to be provided with the health care service to the user device comprises:
sending, a request for a call connection by a communication terminal corresponding to the health care server by using a UPnP telephony service; and
performing the call connection between the communication terminal and the user device by using the UPnP telephony service.

4. The method of claim 1, wherein the situation occurrence information contains situation information indicating the situation, and an identifier of the user device.

5. The method of claim 4, wherein identifying health care information of the user based on the situation occurrence information comprises identifying the situation information and the identifier of the user device.

6. The method of claim 1, wherein the health care information contains an identifier of the user corresponding to the user device, information corresponding to a medical history of the user, and information corresponding to a symptom of the user.

7. A method of receiving a health care service by a user device comprised in a Universal Plug and Play (UPnP) network, comprising:
receiving, from a user, an occurrence of a situation, which has occurred to the user;
generating situation occurrence information based on the occurrence of the situation; and
sending, to a gateway device comprised in the UPnP network, a request for the health care service by transmitting the situation occurrence information.

8. The method of claim 7, further comprising:
performing a call with a health care server connected through the gateway device by using a UPnP telephony service.

9. The method of claim 7, wherein sending the request for the health care service comprises:
transmitting situation information indicating the situation and an identifier of the user device.

10. The method of claim 7, wherein transmitting the situation occurrence information to the gateway device comprises:
transmitting an event message, which informs that the situation has occurred to the user, to the gateway device;
receiving a request for transmitting situation information indicating the situation and an identifier of the user device from the gateway device; and
transmitting the situation information and the identifier of the user device to the gateway device.

11. An apparatus for providing a health care service, comprising:
a health care processor for receiving situation occurrence information indicating an occurrence of a situation, which has occurred to a user, from a user device included in a Universal Plug and Play (UPnP) network, identifying situation information comprised in the situation occurrence information and health care information on the user, and controlling to a data transmission data processor to send a request to be provided with the health care service to the user device; and
the data transmission processor for providing the health care information on the user to a health care server in order to provide the health care service.

12. The apparatus of claim 11, wherein the health care processor controls the data transmission processor to inform the health care server of the situation in order to perform the request to be provided with the health care service.

13. The apparatus of claim 11, wherein the health care processor instructs a telephony Control Point (CP) for performing a UPnP telephony service to perform a call connection with a communication terminal corresponding to the health care service in order to perform the request to be provided with the health care service.

14. The apparatus of claim 13, wherein the telephony CP performs a call connection with the communication terminal and the user device corresponding to the health care service by using the UPnP telephony service.

15. The apparatus of claim 11, wherein the situation occurrence information contains the situation information indicating the situation, and an identifier of the user device.

16. The apparatus of claim 15, wherein the health care processor identifies the situation information and the identifier of the user device.

17. The apparatus of claim 11, wherein the health care information contains an identifier for identifying the user corresponding to the user device, information corresponding to a medical history of the user, and information corresponding to a symptom of the user.
